(19) United States
(12) Patent Application Publication
(10) Pub. No.: US 2010/0076795 A1
(43) Pub. Date: Mar. 25, 2010

(54) OFFERING ACQUIRED AIR TRANSPORT RIGHTS AND SHARING RESULTING REVENUES

(76) Inventors: Robert Steir, New York, NY (US); Kevin Herzberg, Northridge, CA (US); Michael Chirveno, Gladstone, MO (US)

Correspondence Address: GTC Law Group LLP & Affiliates, P.O. Box 113237, Pittsburgh, PA, 15241, US

(21) Appl. No.: 12/561,864

(22) Filed: Sep. 17, 2009

Related U.S. Application Data
(60) Provisional application No. 61/192,203, filed on Sep. 17, 2008.

(51) Int. Cl. G06Q 10/00

(52) U.S. Cl. 705/5; 705/1.1

(57) ABSTRACT

A private air charter transport sharing platform facilitates an original booking party entering into a transportation agreement with an air charter operator, wherein the original booking party receives rights to air transport covered by the agreement. The original booking party offers a portion of the received rights to potential incremental passengers for a passenger fee. As a result of acceptance of the offering the passenger fee is shared among the air charter operator and the original booking party.

### CROSS-REFERENCE TO RELATED APPLICATIONS

This application claims the benefit of U.S. Provisional Patent application Ser. No. 61/192,203, filed Sep. 17, 2008 which is hereby incorporated by reference in its entirety.

### BACKGROUND

1. Field

The methods and systems described herein generally relate to private air charter seat utilization; and particularly relate to offering transportation rights acquired in a private air charter booking to predetermined incremental passengers.

2. Description of the Related Art

Historically, the air charter business has been a regional business where local ACO worked closely with their corporate and individual clients to “rent” or “lease” the entire aircraft for business and personal trips. Individual seats were not sold, nor listed for sale. Typically, the ACO would fly the booking party (from one person to 100% seat capacity) from Point A to Point B. Then the ACO would either stay grounded at the airport or fly back from Point B to Point A “empty” until it was needed by the OBP for the return trip. Then, the ACO would fly, again, from Point A to Point B to pick up the OBP and return back again, flying four flight segments for each hired roundtrip flight. Therefore, air charter flights have always been very expensive to accommodate these two to four legs of a trip, where the direct costs are pilot(s) and crew time and for jet fuel. In the last several years, a few Web-based air charter reservations services have been launched which allow travelers to view available aircraft inventory and book flights from a displayed list of multiple air charter companies, for specific selected dates and prices, and offer these flight services to the public. These services mimic the commercial flight industry, where Web-based travel companies like Expedia, Travelocity and Orbitz command most of the market share.

In addition, due to technical advances in jet aircraft and lower costs associated with these new planes, several small commercial airline services have sprung up to service passengers on scheduled routes utilizing small passenger jets. These companies, known as Air Charter Taxi Services, have emerged which sell individual seats on trips, much like the larger public airlines do, except these routes generally originate and terminate at smaller general aviation airports.

In these existing services the arranged transportation transaction is between the transportation provider and the booking party, where a reservation is made, monies are paid or are pledged to be exchanged for services rendered, i.e. the flight, either one-way, roundtrip or multi-leg. The transportation provider or owner-operator has significant control over what flights are offered and under what terms. A need exists for methods and systems that provide booking parties with greater control over transportation offerings.

### SUMMARY

The methods and systems described herein change the paradigm of air charter travel by shifting control of the process from an operator-owner offering flights for purchase to the booking party. In an aspect of the invention disclosed herein, a Web-based application process and membership service (WAPMS) or platform can facilitate a company or individual booking travel on privately booked charter aircraft.

By entering into a transportation transaction with an air charter owner and operator, including but not limited to sole owners, fractional owners, aircraft charter owners and operators (“the ACO”) an original booking party (OBP) may invite other passengers (the “incremental passengers” or “IP”) to share the available seats and/or the entire empty leg(s) of the potential flight segments (or legs) of an air charter trip. The OBP's solicitations may be transacted through a systematical hierarchical software and multi-contact process that incorporates seat pricing and flight segment guidelines agreed upon by the ACO and OBP. All parties benefit from this financial flight-sharing fee structure and payment sharing process. The entity that owns and manages the WAPMS is hereinafter known as the company, platform facilitator, or platform operator.

The OBP is able to offset costs for its air charter flights, by receiving a portion of the flight costs paid by IP or by benefiting from reduced flight costs charged by the ACO as a result of IP paying a portion of the flight costs to the ACO for sharing the available seats on the OBP's flights or its empty legs. A typical booking will involve the OBP departing from Point A to Point B and returning from Point B to Point A. First, the OBP can offer available seats on its own flight segments. Second, oftentimes, the ACO will drop off the OBP at Point B and then fly the aircraft back to either its home base or other location and then fly the aircraft to retrieve the OBP at Point B and fly to Point A. Therefore, the empty legs are available for paying IP and provide revenue opportunities to the OBP. This can reduce the total cost of the air charter flights for the OBP. The Web-based application will also provide an additional revenue reward to the ACO to fly passengers on what would have otherwise been empty legs. Further, WAPMS will provide suggested routings to ACO for potential empty legs when an OBP requests a flight. The suggested routings will be based on known popular routes which would easily coordinate with the OBP's original booking request.

An aspect of the present invention includes a Web-based application process and membership service (herein referred to as “WAPMS”) that facilitates fulfilling offerings associated with an arranged transportation transaction between the transportation provider (e.g. air charter operator) and the original booking party (herein referred to as “OBP”). In the aspect, the transportation transaction establishes an agreement to provide transport for the OBP in a multi-passenger vehicle from at least Point A to Point B and optionally from Point B to Point A or Point C to Point A at dates and times described by the OBP. This Web-based application process enables the OBP to form an agreement with the transportation provider to share available seats within the vehicle from Point A to B and Point B to A or Point C to A, or variations thereof, as well as permit usage of entire empty legs (e.g. all seats covered by the transportation transaction), if any, in the point-to-point transport.

In an example, this process links air charter owners and operators, including but not limited to sole owners, fractional owners, aircraft charter owners and operators (singly or collectively, the “ACO”) with corporations and individuals (herein referred to as Incremental Passengers (IP)) who are seeking to fly on private air charter flights controlled by an OBP, such as trough the transportation transaction. This process enables a multi-party transaction among the OBP, ACO, the Incremental Passengers (“IP”), and potentially a facilitator or operator of the process. The OBP and ACO may agree to pricing guidelines for the flights and the IP may purchase available seating at passenger fees agreed upon by the OBP and ACO.

IP may be classified into at least four distinct categories, which are summarized herein. The OBP may control which IP receives email or other notifications of its available seats or flight legs as well as the timing of such notices.

Each OBP may be a member (the “Member”) of the WAPMS. Each Member may provide a profile of the Member's organization which will list frequently flown flight routings, catering preferences, transportation modes, and baggage estimations as well as other details to make the charter experience more enjoyable and valuable to the Member. Additionally, the Member may designate preferred passengers (“the “PP”). The PP may either have a connection to the Member or may be companies that may fly similar routings. The PP may be one of the recipients of notifications of the Member's flights. The PP and the IP may also be members of the WAPMS.

The OBP may set the price/passenger fee for the additional seats offered, the empty leg(s), if any, and/or the individual seats thereon. Pricing may be skewed so that the PP may pay a lower passenger fee than other IP. The ACO may receive a predetermined payment for PP or IP on legs attended by the OBP or for empty leg(s) that fly with IP aboard.

If an air charter broker or OBP makes flight arrangements outside of the WAPMS, available seats on these flight segments may also be listed by the OBP into the WAPMS, and the seats may be accessed by Members of the WAPMS under the parameters chosen by the OBP.

This invention changes the paradigm of air charter services by facilitating the offering of seats by an OBP on its charter flight to other passengers, using the additional revenue to offset its own flight costs, and providing additional revenue incentives to the ACO.

This invention may include five distinct operational parts:

1) Methods and systems by which the OBP—the entity that generates the initial flight—directs the IP offerings for all related flight segments;

2) Methods and systems controlled by the OBP to facilitate use of all flight segments of a private air charter trip divided into distinct passenger seating opportunities;

3) Delineating different types of passengers to facilitate supporting OBP preferences for offering seats;

4) A systematic hierarchical Web-based computer software and multi-contact process for soliciting, negotiating with and engaging IP; and

5) A financial flight-sharing fee structure and payment system that rewards all participants, including the ACO, IP, OBP and the Company, by leveraging and monetizing some inefficiencies that exist in the air charter industry.

A Web-based application process and membership service is provided that permits an air charter travel original booking party to invite other passengers to access the available seats on all flight segments that are contained in and/or may be related to the original booking through a systematic hierarchical multi-contact process.

All participants agree to a financial flight-sharing fee structure and payment system managed by the Web-based application that rewards each participants, including the air charter operator who may receive additional revenue, the passengers who book seats and/or empty legs at a typically discounted rate for air charter travel, and the original booking party, which lowers its overall cost of the trip by receiving a share of the incremental passenger fee payments, a reduced fare due to the contributions made by incremental passengers, combinations thereof, and the like. In embodiments the original booking party is the entity that generates the initial private air charter plan and that directs the additional bookings for all related flight segments, by (1) setting, posting and negotiating pricing, (2) choosing the timing of email or other solicitations to incremental passenger prospects, (3) determining the parties to whom such notices are sent. In an example, after flights are completed, the Web-based application distributes the monies paid under a predetermined flight-sharing fee structure.

In an aspect of the invention, methods and systems include entering into a transportation agreement with an air charter operator, wherein an original booking party receives rights to air transport covered by the agreement; offering a portion of the received rights to incremental passengers for a passenger fee; and as a result of acceptance of the offering, sharing the passenger fee among the air charter operator and the original booking party. In the aspect, the portion of the received rights includes an empty leg covered by the agreement. In the aspect, the transportation agreement includes exclusive use of an aircraft. In the aspect, the portion of the received rights includes exclusive use of an aircraft.

In the aspect, the rights to air transport include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, or exclusive use of an aircraft for a plurality of legs. In the aspect, the portion of the received rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, exclusive use of an aircraft for a plurality of legs

In the aspect, offering includes presenting an offer of a portion of the received rights on behalf of the original booking party. In the aspect, the original booking party agrees to pay a transport fee for the rights covered by the transportation agreement. Further in the aspect, the transport fee is adjustable based on the passenger fee. In the aspect, the received rights include transportation of at least one passenger associated with the original booking party from an origin to a first destination. In the aspect, the received rights include use of an aircraft for transportation between an origin and a first destination. In the aspect, the received rights allow offering a portion of the rights to third parties. In the aspect, a portion of the rights is offered by the original booking party.

In the aspect, at least one of the incremental passengers is selected by the original booking party. In the aspect, the incremental passengers to whom a portion of the received rights is offered is selected by the original booking party. In the aspect, the portion of the received rights to be offered is selected by the original booking party. In the aspect, the portion of the received rights provides simultaneous transportation of the original booking party and the incremental passengers. In the aspect, the portion of the received rights provides transportation of only the incremental passengers. In the aspect, the portion of the received rights being offered includes use at least one passenger seat from at least one of an origin to a destination and the destination to the origin. In the aspect, the passenger fee is determined by the original booking party.

In the aspect, a share of the passenger fee shared with the air charter operator is fixed. In the aspect, an air charter operator share of the passenger fee to be shared with the air charter operator is adjustable. In the aspect, the air charter operator share is adjustable based on the passenger fee. In the aspect, the air charter operator share is adjustable based on characteristics of the incremental passenger. In the aspect, the air charter operator share is adjustable based the number of acceptances. In the aspect, an original booking party share comprises a Carbon Credit offset. In the aspect, an air charter operator share includes contributions to a fund to offset future ATC compliance costs.

In the aspect, the incremental passengers are categorized into pricing groups. In the aspect, the passenger fee is adjustable based on the pricing groups. In the aspect, the incremental passengers are preferred passengers. In the aspect, the incremental passengers are corporate members. In the aspect, the incremental passengers are one-time purchasers.

In the aspect, offering a portion of the received rights to incremental passengers includes offering the portion to a first incremental passenger before offering the portion to a second incremental passenger. In the aspect, offering the portion to the second incremental passenger occurs after the first incremental passenger declines the portion. In the aspect, offering the portion to the second incremental passenger occurs automatically based on an elapsed time since offering the portion to the first incremental passenger. In the aspect, offering a portion of the received rights to incremental passengers includes offering the portion to at least one incremental passenger selected from an ordered list of incremental passengers. In the aspect, the at least one incremental passenger is a preferred passenger.

In another aspect of the invention, methods and systems include receiving a description of rights to air transport covered by an air transportation agreement with an air charter operator, wherein the rights are received by an original booking party; determining, using a microprocessor, a subset of potential incremental passengers to receive a transport offer from the original booking party; notifying a portion of the subset of potential incremental passengers of an available portion of the received rights, wherein the available portion of the received rights are offered in exchange for a passenger fee; and as a result of acceptance of the offered available portion of the received rights, sharing the passenger fee among the air charter operator and the original booking party.

In the aspect, the portion of the received rights includes an empty leg covered by the agreement. In the aspect, the transportation agreement includes exclusive use of an aircraft. In the aspect, the portion of the received rights includes exclusive use of an aircraft.

In the aspect, the rights to air transport include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs. In the aspect, the portion of the received rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs.

In the aspect, notifying includes presenting an offer of a portion of the received rights on behalf of the original booking party. In the aspect, the original booking party agrees to pay a transport fee for the rights covered by the transportation agreement. In the aspect, the transport fee is adjustable based on the passenger fee. In the aspect, the received rights include transportation of at least one passenger associated with the original booking party from an origin to a first destination. In the aspect, the received rights include use of an aircraft for transportation between an origin and a first destination. In the aspect, the received rights allow offering a portion of the rights to third parties. In the aspect, a portion of the rights is offered by the original booking party.

In the aspect, at least one of the incremental passengers is selected by the original booking party. In the aspect, the incremental passengers to which a portion of the received rights is offered is selected by the original booking party. In the aspect, the portion of the received rights to be offered is selected by the original booking party. In the aspect, the portion of the received rights provides simultaneous transportation of the original booking party and the incremental passengers. In the aspect, the portion of the received rights provides transportation of only the incremental passengers. In the aspect, the portion of the received rights being offered includes use at least one passenger seat from at least one of an origin to a destination and the destination to the origin. In the aspect, the passenger fee is determined by the original booking party.

In the aspect, a share of the passenger fee shared with the air charter operator is fixed. In the aspect, an air charter operator share of the passenger fee to be shared with the air charter operator is adjustable. In the aspect, the air charter operator share is adjustable based on the passenger fee. In the aspect, the air charter operator share is adjustable based on characteristics of the incremental passenger. In the aspect, the air charter operator share is adjustable based the number of acceptances. In the aspect, an original booking party share comprises a Carbon Credit offset. In the aspect, an air charter operator share includes contributions to a fund to offset future ATC compliance costs. In the aspect, the incremental passengers are categorized into pricing groups.

In the aspect, the passenger fee is adjustable based on the pricing groups. In the aspect, the incremental passengers are any of preferred passengers, corporate members, and one-time purchasers.

In the aspect, notifying a subset of potential incremental passengers includes notifying a first incremental passenger before notifying a second incremental passenger. In the aspect, notifying the second incremental passenger occurs after the first incremental passenger declines the portion. In the aspect, notifying the second incremental passenger occurs automatically based on an elapsed time since notifying the first incremental passenger. In the aspect, notifying the incremental passengers includes notifying at least one incremental passenger selected from an ordered list of incremental passengers. In the aspect, the at least one incremental passenger is a preferred passenger.

In yet another aspect of the invention, methods and systems include receiving, in a transport rights sharing platform, a description of original booking party rights for air transport covered by a transportation agreement with an air charter operator; receiving in the platform a description of a portion of the original booking party rights to be offered to incremental passengers; offering through the platform a portion of the original booking party rights to incremental passengers for a passenger fee; and as a result of acceptance of the offering, sharing the passenger fee among the air charter operator, the original booking party, and an operator of the platform.

In the aspect the portion of the original booking party rights includes an empty leg covered by the agreement. In the aspect the transportation agreement includes exclusive use of an aircraft. In the aspect the portion of the original booking party rights includes exclusive use of an aircraft. In the aspect the rights to air transport include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs. In the aspect the portion of the original booking party rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs.

In the aspect offering includes presenting an offer of a portion of the original booking party rights on behalf of the original booking party. In the aspect the original booking party agrees to pay a transport fee for the rights covered by the transportation agreement. In the aspect the transport fee is adjustable based on the passenger fee. In the aspect the original booking party rights include transportation of at least one passenger associated with the original booking party from an origin to a first destination. In the aspect the original booking party rights include use of an aircraft for transportation between an origin and a first destination. In the aspect the original booking party rights allow offering a portion of the rights to third parties. In the aspect a portion of the rights is offered by the original booking party.

In the aspect at least one of the incremental passengers is selected by the original booking party. In the aspect the incremental passengers to which a portion of the original booking party rights is offered is selected by the original booking party. In the aspect the portion of the original booking party rights to be offered is selected by the original booking party. In the aspect the portion of the original booking party rights provides simultaneous transportation of the original booking party and the incremental passengers. In the aspect the portion of the original booking party rights provides transportation of only the incremental passengers. In the aspect the portion of the original booking party rights being offered includes use at least one passenger seat from at least one of an origin to a destination and the destination to the origin.

In the aspect the passenger fee is determined by the original booking party. In the aspect a share of the passenger fee shared with the air charter operator is fixed. In the aspect an air charter operator share of the passenger fee to be shared with the air charter operator is adjustable. In the aspect, the air charter operator share is adjustable based on the passenger fee. In the aspect, the air charter operator share is adjustable based on characteristics of the incremental passenger. In the aspect the air charter operator share is adjustable based the number of acceptances. In the aspect an original booking party share comprises a Carbon Credit offset. In the aspect, an air charter operator share includes contributions to a fund to offset future ATC compliance costs. In the aspect the incremental passengers are categorized into pricing groups. In the aspect, the passenger fee is adjustable based on the pricing groups. In the aspect, the incremental passengers are any of preferred passengers, corporate members, and one-time purchasers.

In the aspect offering a portion of the original booking party rights to incremental passengers includes offering the portion to a first incremental passenger before offering the portion to a second incremental passenger. In the aspect, offering the portion to the second incremental passenger occurs after the first incremental passenger declines the portion. In the aspect, offering the portion to the second incremental passenger occurs automatically based on an elapsed time since offering the portion to the first incremental passenger. In the aspect offering a portion of the original booking party rights to incremental passengers includes offering the portion to at least one incremental passenger selected from an ordered list of incremental passengers. In the aspect the at least one incremental passenger is a preferred passenger. In the aspect offering includes: accessing a database of potential incremental passengers; determining a match between the rights to be offered with transportation metadata associated with the potential incremental passengers; and based on the match delivering the offerings to at least one potential incremental passenger. In the aspect the description of original booking party rights includes information about a flight.

In the aspect, the information about a flight includes at least one of dates of the flight, flight segments and corresponding itinerary, the aircraft type, the number of seats it reserves on each segment flight, and the flight operator. In the aspect, the description of original booking party rights includes information about the original booking party flexibility regarding dates and destinations

In yet another aspect of the invention, methods and systems include receiving, in a transport rights sharing platform operating on a microprocessor, a description of original booking party rights for air transport covered by a transportation agreement with an air charter operator; receiving in the platform a description of a portion of the original booking party rights to be offered to incremental passengers; offering through the platform a portion of the original booking party rights to incremental passengers for a passenger fee; and as a result of acceptance of the offering, sharing the passenger fee among the air charter operator, the original booking party, and an operator of the platform.

In the aspect the portion of the original booking party rights includes an empty leg covered by the agreement. In the aspect the transportation agreement includes exclusive use of an aircraft. In the aspect the portion of the original booking party rights includes exclusive use of an aircraft. In the aspect the rights to air transport include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs. In the aspect the portion of the original booking party rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs.

In the aspect offering includes presenting an offer of a portion of the original booking party rights on behalf of the original booking party. In the aspect the original booking party agrees to pay a transport fee for the rights covered by the transportation agreement. In the aspect the transport fee is adjustable based on the passenger fee. In the aspect the original booking party rights include transportation of at least one passenger associated with the original booking party from an origin to a first destination. In the aspect, the original booking party rights include use of an aircraft for transportation between an origin and a first destination. In the aspect the original booking party rights allow offering a portion of the rights to third parties. In the aspect a portion of the rights is offered by the original booking party.

In the aspect at least one of the incremental passengers is selected by the original booking party. In the aspect the incremental passengers to which a portion of the original booking party rights is offered is selected by the original booking party. In the aspect the portion of the original booking party rights to be offered is selected by the original booking party. In the aspect the portion of the original booking party rights provides simultaneous transportation of the original booking party and the incremental passengers. In the aspect the portion of the original booking party rights provides transportation of only the incremental passengers. In the aspect the portion of the original booking party rights being offered includes use at least one passenger seat from at least one of an origin to a destination and the destination to the origin.

In the aspect the passenger fee is determined by the original booking party. In the aspect a share of the passenger fee shared with the air charter operator is fixed. In the aspect an air charter operator share of the passenger fee to be shared with the air charter operator is adjustable. In the aspect, the air charter operator share is adjustable based on the passenger fee. In the aspect, the air charter operator share is adjustable based on characteristics of the incremental passenger. In the aspect the air charter operator share is adjustable based the number of acceptances. In the aspect an original booking party share comprises a Carbon Credit offset. In the aspect, an air charter operator share includes contributions to a fund to offset future ATC compliance costs.

In the aspect the incremental passengers are categorized into pricing groups. In the aspect, in the passenger fee is adjustable based on the pricing groups. In the aspect, the incremental passengers are any of preferred passengers, corporate members, and one-time purchasers.

In the aspect offering a portion of the original booking party rights to incremental passengers includes offering the portion to a first incremental passenger before offering the portion to a second incremental passenger. In the aspect, offering the portion to the second incremental passenger occurs after the first incremental passenger declines the portion. In the aspect, offering the portion to the second incremental passenger occurs automatically based on an elapsed time since offering the portion to the first incremental passenger. In the aspect offering a portion of the original booking party rights to incremental passengers includes offering the portion to at least one incremental passenger selected from an ordered list of incremental passengers. In the aspect the at least one incremental passenger is a preferred passenger.

In the aspect offering includes: accessing a database of potential incremental passengers; determining a match between the rights to be offered with transportation metadata associated with the potential incremental passengers; and based on the match delivering the offerings to at least one potential incremental passenger.

In the aspect the description of original booking party rights includes information about a flight. In the aspect, the information about a flight includes at least one of dates of the flight, flight segments and corresponding itinerary, the aircraft type, the number of seats it reserves on each segment flight, and the flight operator. In the aspect, the description of original booking party rights includes information about the original booking party flexibility regarding dates and destinations.

In still yet another aspect of the invention, methods and systems include receiving in a transport rights sharing platform a description of original booking party rights for air transport covered by a transportation agreement with an air charter operator; making a recommendation with the platform of a portion of the original booking party rights to be offered to incremental passengers; and based on receiving from the original booking party acceptance of the recommendation, facilitating an offer of the portion of the original booking party rights to incremental passengers.

In the aspect the recommendation is based on terms of the transportation agreement. In the aspect, the terms include unused seat guidelines. In the aspect, the terms includes empty flight segment guidelines. In the aspect, the terms include interim flight segment guidelines.

In the aspect the portion of the original booking party rights includes a passenger fee. In the aspect the passenger fee is recommended by the transportation rights sharing platform.

In the aspect the portion of the original booking party rights includes an empty leg covered by the agreement. In the aspect the transportation agreement includes exclusive use of an aircraft. In the aspect the portion of the original booking party rights includes exclusive use of an aircraft. In the aspect the rights to air transport include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs. In the aspect the portion of the original booking party rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs.

In the aspect facilitating an offer includes presenting an offer of a portion of the original booking party rights on behalf of the original booking party. In the aspect the original booking party agrees to pay a transport fee for the rights covered by the transportation agreement. In the aspect the transport fee is adjustable based on the passenger fee. In the aspect the original booking party rights include transportation of at least one passenger associated with the original booking party from an origin to a first destination. In the aspect, the original booking party rights include use of an aircraft for transportation between an origin and a first destination. In the aspect the original booking party rights allow offering a portion of the rights to third parties. In the aspect a portion of the rights is offered by the original booking party.

In the aspect at least one of the incremental passengers is selected by the original booking party. In the aspect the incremental passengers to which a portion of the original booking party rights is offered is selected by the original booking party. In the aspect the portion of the original booking party rights to be offered is selected by the original booking party. In the aspect the portion of the original booking party rights provides simultaneous transportation of the original booking party and the incremental passengers. In the aspect the portion of the original booking party rights provides transportation of only the incremental passengers. In the aspect the portion of the original booking party rights being offered includes use at least one passenger seat from at least one of an origin to a destination and the destination to the origin. In the aspect the passenger fee is determined by the original booking party.

In the aspect, the incremental passengers are categorized into pricing groups. In the aspect, the passenger fee is adjustable based on the pricing groups. In the aspect, the incremental passengers are any of preferred passengers, corporate members, and one-time purchasers.

In the aspect, facilitating an offer of a portion of the original booking party rights to incremental passengers includes facilitating an offer to a first incremental passenger before facilitating an offer to a second incremental passenger. In the aspect, facilitating an offer to the second incremental passenger occurs after the first incremental passenger declines the portion. In the aspect, facilitating an offer to the second incremental passenger occurs automatically based on an elapsed time since facilitating an offer to the first incremental passenger. In the aspect facilitating an offer to incremental passengers includes facilitating an offer to at least one incremental passenger selected from an ordered list of incremental passengers. In the aspect the at least one incremental passenger is a preferred passenger.

In the aspect facilitating an offer includes: accessing a database of potential incremental passengers; determining a match between the rights to be offered with transportation metadata associated with the potential incremental passengers; and based on the match facilitating delivery of the offer to at least one potential incremental passenger. In the aspect the description of original booking party rights includes information about a flight. In the aspect, the information about a flight includes at least one of dates of the flight, flight segments and corresponding itinerary, the aircraft type, the number of seats it reserves on each segment flight, and the flight operator. In the aspect, the description of original booking party rights includes information about the original booking party flexibility regarding dates and destinations

In another aspect of the invention, methods and systems include an exchange in which original booking parties acquire transportation rights for air charter service and offer a portion of the acquired rights to incremental passengers, wherein incremental passengers acquire the offered rights for a fee that is shared among the original booking party, an operator of the air charter service, and an operator of the exchange.

In another aspect of the invention, methods and systems include an exchange in which original booking parties acquire transportation rights for air charter service and offer a portion of the acquired rights to incremental passengers wherein incremental passengers acquire the offered rights for a fee that is shared among the original booking party, an operator of the air charter service, and an operator of the exchange, and wherein broker travel partners offer access to available seats offered by an original booking party through the exchange. In the aspect the broker travel partners share a portion of fee.

In another aspect of the invention, methods and systems include a hierarchical web-based system for facilitating an offer of a portion of acquired air transportation rights, comprising: a communication and notification facility for providing time-based offers of a portion of the acquired air transportation rights to incremental passengers using a hierarchical notification process; a rights offer guideline facility for providing seat pricing and flight segment guidelines; a reservation facility for accepting the time-based offers; and a transaction facility to facilitate purchasing the offered rights.

In the aspect the time-based offers are provided by an electronic message. In the aspect the electronic message includes a phone message.

In the aspect the portion of the acquired air transportation rights includes an empty leg. In the aspect the acquired air transportation rights includes exclusive use of an aircraft. In the aspect the portion of the acquired air transportation rights includes exclusive use of an aircraft. In the aspect the acquired air transportation rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs. In the aspect the portion of the acquired air transportation rights include any of a seat for a leg, a plurality of seats for a leg, all seats in an aircraft for a leg, exclusive use of an aircraft for a leg, a seat for a plurality of legs, a plurality of seats for a plurality of legs, all seats in an aircraft for a plurality of legs, and exclusive use of an aircraft for a plurality of legs.

In the aspect facilitating an offer includes presenting an offer of a portion of the acquired air transportation rights on behalf of an original booking party. In the aspect the acquired air transportation rights include transportation of at least one passenger associated with an original booking party from an origin to a first destination. In the aspect, the acquired air transportation rights include use of an aircraft for transportation between an origin and a first destination. In the aspect the acquired air transportation rights allow offering a portion of the rights to third parties. In the aspect a portion of the rights is offered by an original booking party.

In the aspect at least one of the incremental passengers is selected by an original booking party. In the aspect the incremental passengers to which a portion of the acquired air transportation rights is offered is selected by an original booking party. In the aspect the portion of the acquired air transportation rights to be offered is selected by an original booking party. In the aspect the portion of the acquired air transportation rights provides simultaneous transportation of an original booking party and the incremental passengers. In the aspect the portion of the acquired air transportation rights provides transportation of only the incremental passengers. In the aspect the portion of the acquired air transportation rights being offered includes use at least one passenger seat from at least one of an origin to a destination and the destination to the origin.

In the aspect the passenger fee is determined by an original booking party. In the aspect, the incremental passengers are categorized into pricing groups. In the aspect, the passenger fee is adjustable based on the pricing groups. In the aspect, the incremental passengers are any of preferred passengers, corporate members, and one-time purchasers.

In the aspect facilitating an offer a portion of the acquired air transportation rights to incremental passengers includes facilitating an offer to a first incremental passenger before facilitating an offer to a second incremental passenger. In the aspect, facilitating an offer to the second incremental passenger occurs after the first incremental passenger declines the portion. In the aspect, facilitating an offer to the second incremental passenger occurs automatically based on an elapsed time since facilitating an offer to the first incremental passenger. In the aspect facilitating an offer to incremental passengers includes facilitating an offer to at least one incremental passenger selected from an ordered list of incremental passengers. In the aspect the at least one incremental passenger is a preferred passenger.

In the aspect facilitating an offer includes accessing a database of potential incremental passengers; determining a match between the rights to be offered with transportation metadata associated with the potential incremental passengers; and based on the match facilitating delivery of the offer to at least one potential incremental passenger.

In another aspect of the invention, methods and systems include a software module deployable in a networked computing environment for a transport rights sharing platform, comprising a branding and configuration program for setting up aspects of the platform; a platform participant setup and maintenance program for initiating and maintaining platform participants; an installation program for installing the platform; a host operating program to facilitate a host operating the platform. In the aspect the host is a corporation. In the aspect, the platform participants include employees of the corporation. In the aspect, the host is an air charter broker. In the aspect, the platform participants include any of air charter operators, private jet owners, original booking parties, and incremental passengers. In the aspect the networked computer environment is separated from the internet by a firewall.

In another aspect of the invention, methods and systems include a user interface for a transport rights sharing platform wherein an air charter operator can perform any of the following: input terms for original booking party sharing of rights for transport offered by the air charter operator, view and accept responses by potential original booking parties, view and track offers of rights for transport made by an original booking party, manage passenger fee sharing, and solicit participants of the platform to engage in a private air charter transport agreement.

In another aspect of the invention, methods and systems include a method of incremental passenger interface with a transport rights sharing platform, comprising: receiving a notification of an offer for incremental passenger transportation, wherein the offer is for a portion of rights received by an original booking party for air transport covered by a transportation agreement with an air charter operator; viewing the offer in a user interface of the transport rights sharing platform; and accepting the offer through the user interface.

In another aspect of the invention, methods and systems include a user interface for a transport rights sharing platform, comprising: an electronic presentation of at least one incremental passenger transport offer, wherein the offer is for a portion of rights received by an original booking party for air transport covered by a transportation agreement with an air charter operator; an object that is included in the presentation through which a user of the user interface can accept the offer; and an electronic presentation of confirmation of user acceptance of the offer.

In another aspect of the invention, methods and systems include receiving in a private air charter flight sharing platform a request for transport from a source to a destination, wherein the request includes a request fee payment from an incremental passenger; presenting the request to a plurality of participants in the platform; receiving a description of an initial booking of a private air charter agreement; electronically determining if the request for transport can be provided by the initial booking; and facilitating offering to the incremental passenger a portion of rights received by an original booking party of the initial booking that fulfills the request for transport. In the aspect the request includes a date of travel. In the aspect as a result of acceptance of the offer by the incremental passenger, the original booking party retains the request fee payment. In the aspect acceptance of the offering requires payment of a passenger fee. In the aspect, the passenger fee is shared among parties to the private air charter agreement and a operator of the platform.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 is a block flow diagram representation of the embodiment of the present invention;

FIG. 2 shows seating diagrams representing examples of some of the various flight segments and seating opportunities that may be generated for OBP-controlled flights;

FIG. 3 describes the systematic hierarchical algorithm and multi-contact process within WAPMS that, solicits IP using a time and event based communication and notification process, provides the OBP with seat pricing and flight segment guidelines to use, and provides reservation and transaction services to engage IP to purchase a seat or an entire empty leg on the OBP's generated flight segments for each Initial Booking (“IB”); and

FIG. 4 is a block flow diagram representing the payment and distribution of funds to all parties participating in and facilitating the flight-sharing process.

### DETAILED DESCRIPTION

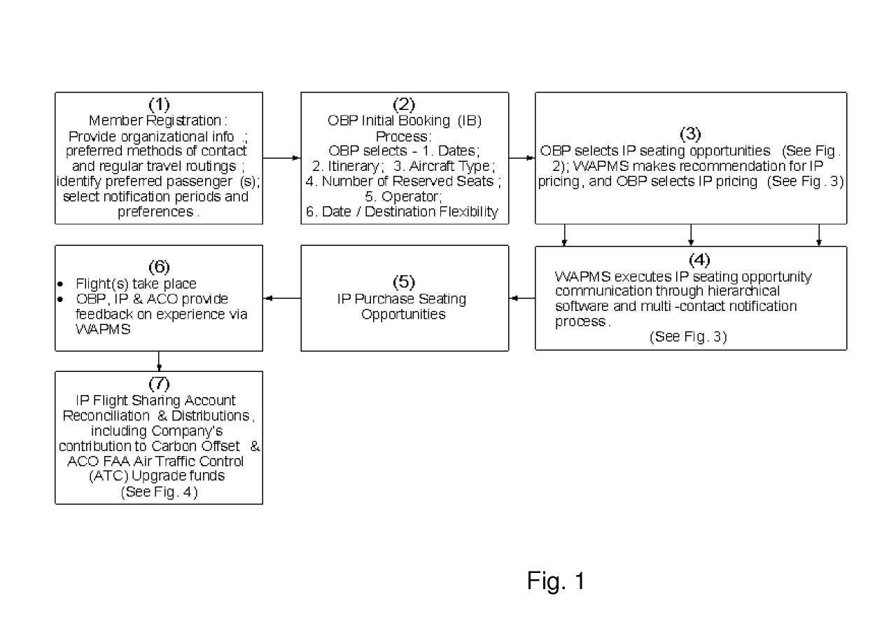

FIG. 1 shows an overview of the process and system of the present invention and provides for the Original Booking Party (“OBP”) to be the controlling responsible entity that generates the initial flight and controls the incremental passengers (“IP”) bookings for all related flight segments.

First, a person or entity will register (--1--) with the WAPMS to become a member of the service (the “Member”) and will provide information regarding their organization or themselves such as traveler(s)' name, address, contact information and preferred methods of contact, regular travel routings and payment information. The Member also lists Preferred Passengers (“PP”) and selects default notification periods for PP and other IP for available seats and legs associated with the Member's bookings.

Second, the Member makes an initial booking for a flight through known travel booking services, such as travel agents or travel Web sites, directly through the ACO itself, or through the Company. The Member is now known as the OBP and the booking is known as an “IB” for initial booking In the IB process, the OBP provides information about the flight (--2--), such as the dates of the flights, flight segments and corresponding itinerary, the aircraft type, the number of seats it reserves on each segment flight, and the flight operator. The OBP also indicates its flexibility regarding dates and destinations.

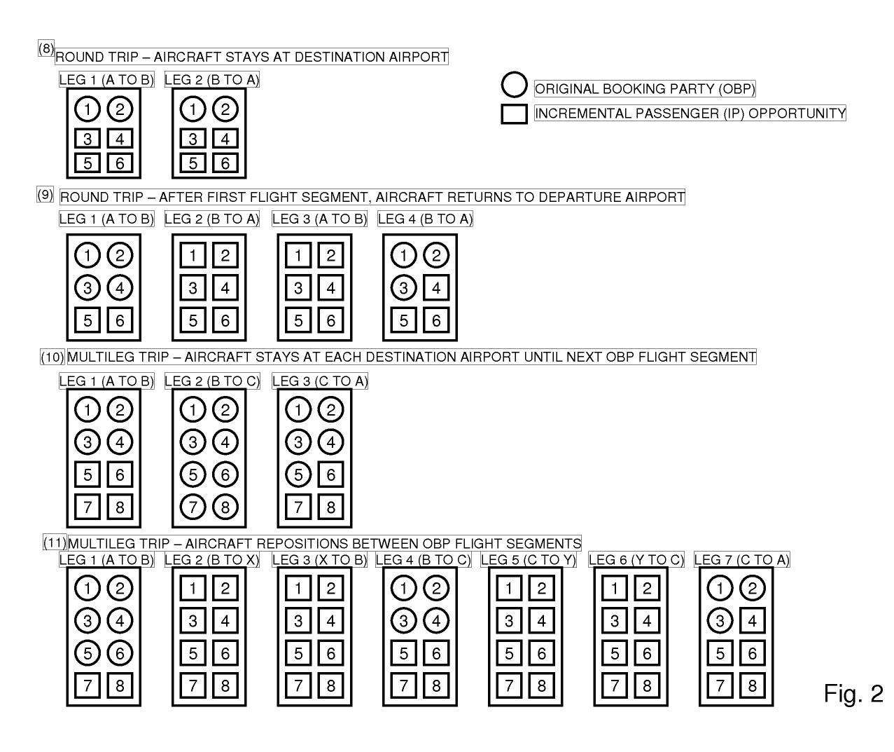

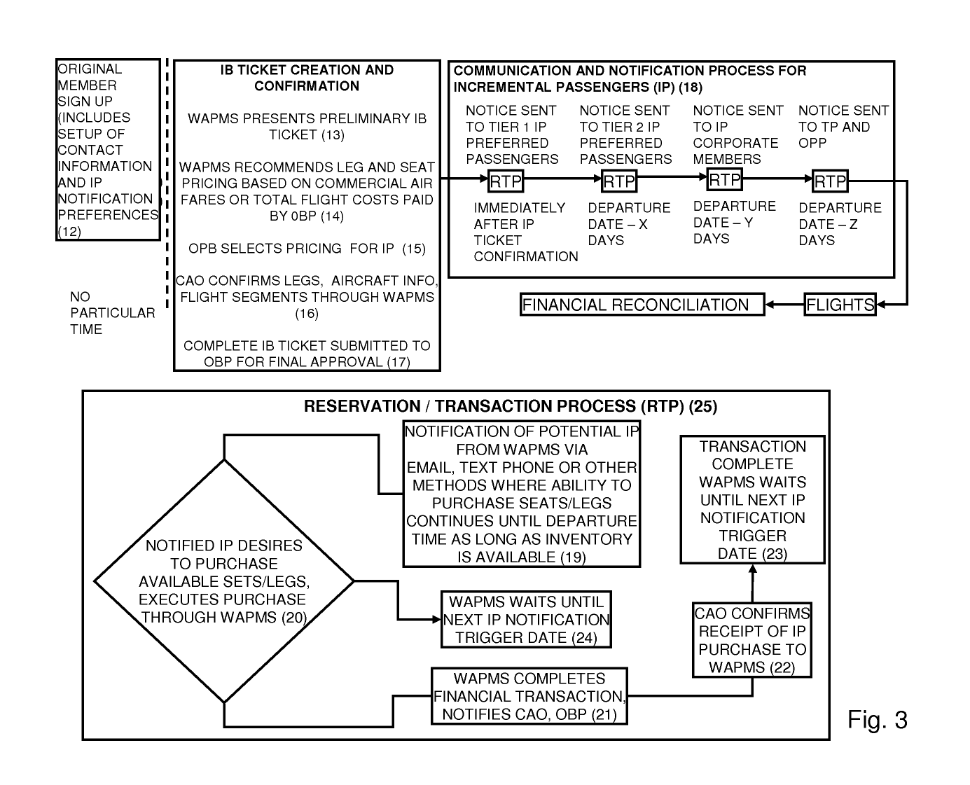

Based on the registration information provided by the OBP during the WAPMS registration process (--1--), and as amended by the Member from time to time, WAPMS makes recommendations for pricing seats/legs to IP incorporating the terms of the agreement between the OBP and ACO regarding seat and empty leg pricing guidelines, and the OBP selects the pricing to be offered to potential IP for flights associated with its IB (--3--). (The methodology for recommending and setting pricing is further described in FIG. 3). The OBP will also select the flight segment's seating opportunities that will be offered to IP (--3--). (Examples of seating opportunities are further described in FIG. 2). Next, the WAPMS will send notifications to potential IP for the available seats or empty legs on these flight segments generated by the OBP's IB (--4--). (This process is further described in FIG. 3.

IP purchase the available seating opportunities through WAPMS (--5--). After the flights take place, the OBP, IP and ACO have the option to complete feedback forms on the flight(s) (--6--). All monies received by the WAPMS from the OBP and the IP are accounted for and shared between the ACO, the OBP, and the Company (--7--) according to the agreed upon terms.

FIG. 2 shows seating diagrams representing examples of variations of possible flight segments generated by OBP flights and seating opportunities for OBP and IP. The following are examples and are not exhaustive of the varying flight segment combinations that an OBP will book and the ACO will fly. This illustrates that all flight segments of an air charter trip can provide IP seating opportunities and thus additional revenues and/or reduced costs for all parties to the arranged transportation transaction. Additionally, Broker Travel Partners (“TP”), as defined below, can offer flight segments and seating opportunities for IP on the WAPMS.

Historically, passengers have made reservations for travel services e.g. a seat on a flight either directly with the flight operator, through a travel agent, or on a travel Web site. These flight operators do not discriminate as to who may fly and who may not fly as long as a ticket is purchased. Thus, all persons have been equally accorded the right to buy a ticket for a seat on a commercially operated flight. These transactions are between the flight purchasers and the flight operator. This invention's operational process is between the OBP and IP. It gives preferential treatment to the IP chosen by the OBP, rather than those chosen by the ACO. IP can be categorized in the following groupings, either as part of a membership organization or independently organized. The following are the different types of passengers and other parties that would use the WAPMS:

a. The OBP (Original Booking Party)

The OBP is the flight originator who determines the routing of the flights.

b. The PP (Preferred Passengers)

A PP is a company, an entity, or an individual that usually has a connection to the OBP or is identified by the WAPMS as having similar flight patterns as the OBP and is approved by the OBP to fly on OBP flights. A list of PP is provided by the OBP upon joining the service and can be amended from time to time. Additionally, the OBP can make subsets of its PP, known as Tier 1 PP, Tier 2 PP, etc., which subsets of PP will receive their notifications in accordance with the timing set forth by the OBP. A PP is a member of the WAPMS.

c. The Corporate Member (the “CM”)

The CM is a company or entity that will book air charter travel using the WAPMS and also is able to be an OBP. The CM is registered by the corporate travel department or key travel booking representative of the company and agrees to rules of engagement as OBP or IP. Dossiers listing travel preferences and other important travel related facts are provided for key executives and frequent travelers of the Corporate Member. A CM is a member of the WAPMS.

d. The One-Time Passenger Purchasers (the “OPP”).

The OPP are one-off purchasers of flight segments or incremental seats. All OPP provide dossiers on travel facts and preferences. OPP are not members of this WAPMS. However, OPP may make application to WAPMS and would need to pass a qualification test. The OPP dossiers on travel facts and preferences may be reviewed and qualified in order to fly on certain flights.

e. The Broker Travel Partner (“TP”)

A TP is an air charter broker or other travel professional that offers empty legs or individual seats on available flight segments of the TP's client's flights. TP's clients may need to provide dossiers on travel facts and preferences. TP may also book travel for its clients on WAPMS and their clients will become OPP.

PP, CM and OPP are collectively called IP.

The first diagram (--8--) represents an OBP IB for round trip travel where the aircraft waits at the destination for the passengers return flight leg. Leg 1 is represented as travel from Point A to Point B and Leg 2 is represented as travel from Point B to Point A. This example shows a six person seating capacity for each flight. The OBP has selected two seats on each of the flight legs. Thus, four seats on each of the legs are seating opportunities for potential IP.

The second diagram (--9--) represents an OBP's IB of a round trip where the aircraft returns to the departure point, its home base or another point after the passengers are dropped off at the destination and then flies back to pick up the passengers for the return flight leg. Thus, the two flight segments which will be flown without passengers are designated by the industry as “empty legs” and these two extra flight segments represent seats available to IP. The ACO usually will set the departure time or time window for the empty leg flights. Leg 1 is represented as travel from Point A to Point B, Leg 2 is represented as travel from Point B to Point A, Leg 3 is represented as travel from Point A to Point B, and Leg 4 is represented as travel from Point B to Point A. The example shows a six person seating capacity for each flight. The OBP has selected four seats on Leg 1 and three seats on Leg 4. Legs 2 and 3 are known as the empty legs and their full seating capacity is available to IP. On Leg 1, two seats are available seating opportunities for IP and on Leg 4, three seats are available seating opportunities for IP.

The third diagram (--10--) represents an OBP's IB for a multi-leg trip where the aircraft waits at each destination for the passengers' next leg. Leg 1 is represented as travel from Point A to Point B, Leg 2 is represented as travel from Point B to Point C, and Leg 3 is represented as travel from Point C to Point A. The example shows an eight person seating capacity for each flight. The OBP has selected four seats on Leg 1, eight seats on Leg 2, and five seats on Leg 3. On Leg 1, four seats are available seating opportunities for IP and on Leg 3, three seats are available seating opportunities for IP.

The fourth diagram (--11--) represents an OBP's IB for a multi-leg trip where the aircraft repositions to another destination between passenger drop offs and pick ups as the OBP IB set travel from Point A to Point B to Point C s to Point A. Empty legs are created for IP opportunities from Point B to Point X and from Point X to Point B and from Point C to Point Y and from Point Y to Point C. Leg 1 is represented as travel from Point A to Point B, Leg 2 is represented as travel from Point B to Point X, Leg 3 is represented as travel from Point X back to Point B, Leg 4 is represented as travel from Point B to Point C, Leg 5 is represented as travel from Point C to Point Y, Leg 6 is represented as travel from Point Y to Point C, and Leg 7 is represented as travel from Point C to Point A. The example shows an eight person seating capacity for each flight. The OBP has selected six seats on Leg 1, four seats on Leg 4, and three seats on Leg 7. Legs 2, 3, 5 and 6 are known as the empty legs and their full seating capacity is available to IP. On Leg 1, two seats are available seating opportunities for IP, on Leg 4, four seats are available seating opportunities for IP and on Leg 7, five seats are available seating opportunities for IP.

FIG. 3 describes the systematic hierarchical Web-based computer software and multi-contact process in WAPMS that solicits IP using a time-based communication and notification process (--18--), provides the OBP with seat pricing and flight segment guidelines to use (--14--) and provides reservation and transaction services to engage IP (--25--) to purchase a seat on the OBP's generated flight segments for each IB.

First, WAPMS combines information input by the OBP during the IB process, with default information input by the OBP during member sign up (--12--) to create a preliminary IB Ticket (--13--) that outlines the entire flight information, number of flight segments, the departures and arrival airports, and pre-populates a pricing scheme for flight segment seats for each IP group (-14--). The OBP, using the WAPMS guidelines which incorporates the agreement between the OBP and the ACO regarding pricing guidelines, determines the pricing scheme (--15--) which can be different for each group of PP and IP, although CM pricing will be based on an algorithm incorporating commercial air fares. For all other IP pricing of seats/flights, the WAPMS provides the OBP with choices (--14--) that are based upon (1) the current commercial air fares for the flight's departure city and destination city for segments between Point A and Point B and the OBP can choose to increase or decrease such estimated fare by any percentage or amount, (2) the total flight costs paid by the OBP and the OBP can use a division function to determine the cost of a seat and gross up the seat cost or decrease it by percentage basis or any amount or (3) any other amount chosen by the OBP, subject to minimum pricing standards set by WAPMS, which may take into account profit margin of ACO. If the OBP flight segments are not commercially available, WAPMS will provide an estimate of such costs for each particular flight segment. The OBP confirms that it will use the IB Ticket as created or has the option of substituting, at will, any of the information listed on the IB Ticket to create the final IB Ticket to be used (--17--). Next, WAPMS, separately, confirms flight segments, aircraft and scheduling information directly with the ACO (--16--), either by a person-to-person phone call, through WAPMS or by other methods.

With the completed and confirmed IB Ticket (--17--), WAPMS calculates the number of days between the initial booking date and the OBP's departure date. Using this total, WAPMS establishes a communication notification process (--18--), in accordance with the parameters set forth on the IB Ticket, including when to initially notify the various tiers of IP groups before the departure date. IP notification can occur via email, text, phone, fax, or links to the IP, based upon the preferred contact method and contact information pre-populated (--1--) for each IP. The communication and notification order flows as follows for each IP (--18--): WAPMS first notifies the OBP's Tier 1 PP after the completed IB Ticket. Then, WAPMS notifies in subsequent order, triggered by the number of days before departure date for the IB Ticket, Tier 2 PP, Tier 3 PP, etc.; CM; TP and OPP.

For each IP group notified, WAPMS provides IP with the same process and opportunity to purchase a seat and conduct a financial transaction which permits the IP to pay for the seat at the time of booking (--20--). As described, the targeted IP group is notified regarding the availability of the flight(s) (--19--), permitted to view the IB Ticket, which is being constantly updated based on seating purchases and OBP revisions to the IB. As the IB Ticket includes flight segments, pricing (with the seat price, based on the pricing scheme, for each IP only viewable to that IP), number of available seats, flight segment departure and arrival times, the targeted IP has the necessary information it needs to purchase available seats or legs from the date notified until a pre-determined number of hours before the departure time (--19--). The IP has the option of contacting WAPMS to book the seat through the online Web page of WAPMS or by telephone or other method. The IP pays WAPMS and WAPMS notifies the ACO (--21--). The ACO, via WAMPS, confirms receipt of booking information (--22--). The transaction is completed and WAPMS waits to notify the next IP group, if seats are still available, on the next IP group notification trigger date (--23--). Likewise, if no transactions are completed by the IP group, WAPMS will wait to notify the next IP group on these IP's notification trigger date(s) (--24--).

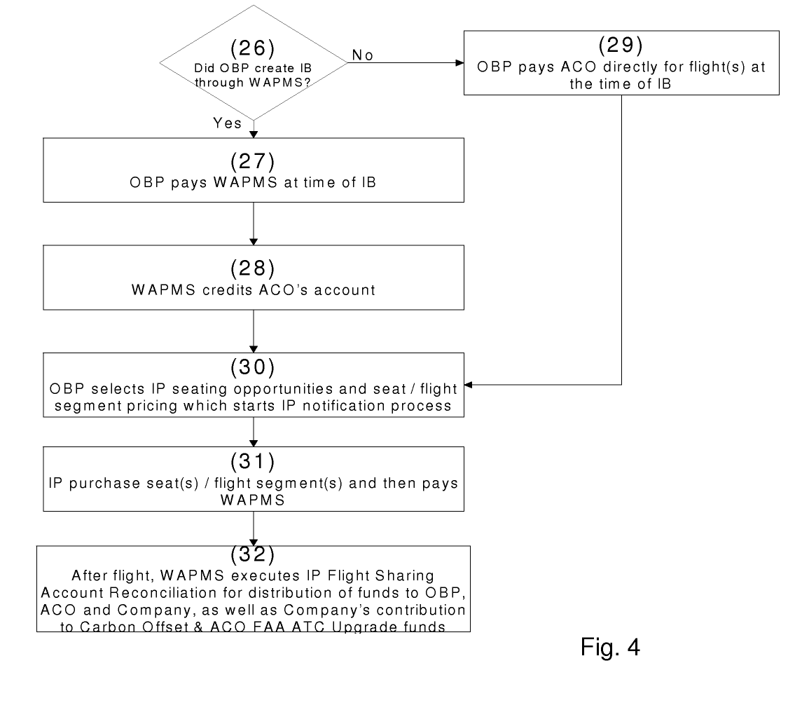

FIG. 4 is a block flow diagram representation of the payment and distribution of funds to parties participating in and facilitating the flight sharing process. This is the invention's financial flight-sharing fee structure that rewards all participants, including the ACO, IP, OBP and the Company, by leveraging and monetizing the inefficiencies that exist in the air charter industry. In a typical transaction between flight operator and OBP, the OBP pays the flight operator, or more likely a travel agent or travel site as intermediary, for a seat between Point A and Point B, and a return flight from Point B to Point A. Empty seats can be viewed as lost income opportunities for the ACO and usually not a concern for the OBP. In WAPMS, the OBP creates and controls seat availability for IP and the revenue generated is shared by the OBP with the ACO, as additional revenue, as well as with the IP, as IP generally pays a lower fare than what would usually be paid for air charter travel.

If the OBP creates the IB thru WAPMS, the OBP pays WAPMS at the time of the IB (--27--). WAPMS in turn credits the ACO's account for OBP booking (--28--) less the Company's commission. If the OBP did not create the IB thru WAPMS, then the OBP pays the ACO directly (--29--). IP purchase available seats/flight segments and pay WAPMS at the time of booking (--31--). TP listing available flights or seats on its client's flights will fall into the same category as an OBP that did not create the IB thru WAPMS. After the flights, WAPMS distributes monies to ACO for flights and additional revenues earned from IP bookings (--32--). The OBP's or TP's account is also credited with its share of the revenues from the IP bookings and monies are either retained in the account or distributed to the OBP, as directed by the Member or for TP's distributed directly thereto (--32--). The Company, through WAPMS, also retains its share of the revenues. All participating parties receive revenues in accordance with the predetermined amounts agreed upon by all parties.

Thus, OBP costs for its original flight booking are now reduced by the OBP's share of the additional revenue generated by IP on the OBP generated flight segments. ACO also earn additional revenues from flights flown by IP on the OBP generated flight segments. The flight sharing arrangement provides a financial incentive to all parties to the arranged transportation transaction.

In addition, the Company will also provide further incentives for OBP, IP and ACO participation in the form of two optional participation programs for each completed transaction: The first involves providing Carbon Offsets (“Carbon Credits”) available as appropriate, based on occupied flights, seat purchasing, and flight sharing scenarios. The second involves providing a way for ACOs to opt-in to set aside a portion of its earned revenues into a savings plan, in some form of account for future FAA ATC costs associated with the FAA's new radar system coming in the next 10 years and the requirement for each ACO to upgrade its planes.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1-51. (canceled)

52. A method comprising:
receiving a description of rights to air transport covered by an air transportation agreement with an air charter operator, wherein the rights are received by an original booking party;
determining, using a microprocessor, a subset of potential incremental passengers to receive a transport offer from the original booking party;
notifying a portion of the subset of potential incremental passengers of an available portion of the received rights, wherein the available portion of the received rights are offered in exchange for a passenger fee; and
as a result of acceptance of the offered available portion of the received rights, sharing the passenger fee among the air charter operator and the original booking party.

53-71. (canceled)

72. The method of claim 52, wherein notifying includes presenting an offer of a portion of the received rights on behalf of the original booking party.

73. The method of claim 52, wherein the original booking party agrees to pay a transport fee for the rights covered by the transportation agreement.

74. The method of claim 73, wherein the transport fee is adjustable based on the passenger fee.

75-77. (canceled)

78. The method of claim 52, wherein a portion of the rights is offered by the original booking party.

79. (canceled)

80. The method of claim 52, wherein the incremental passengers to which a portion of the received rights is offered is selected by the original booking party.

81-97. (canceled)

98. The method of claim 52, wherein notifying a subset of potential incremental passengers includes notifying a first incremental passenger before notifying a second incremental passenger.

99. The method of claim 98, wherein notifying the second incremental passenger occurs after the first incremental passenger declines the portion.

100. The method of claim 98, wherein notifying the second incremental passenger occurs automatically based on an elapsed time since notifying the first incremental passenger.

101-102. (canceled)

103. A method comprising:
receiving, in a transport rights sharing platform, a description of original booking party rights for air transport covered by a transportation agreement with an air charter operator;
receiving in the platform a description of a portion of the original booking party rights to be offered to incremental passengers;
offering through the platform a portion of the original booking party rights to incremental passengers for a passenger fee; and
as a result of acceptance of the offering, sharing the passenger fee among the air charter operator, the original booking party, and an operator of the platform.

104-121. (canceled)

122. The method of claim 103, wherein offering includes presenting an offer of a portion of the original booking party rights on behalf of the original booking party.

123. The method of claim 103, wherein the original booking party agrees to pay a transport fee for the rights covered by the transportation agreement.

124. The method of claim 123, wherein the transport fee is adjustable based on the passenger fee.

125-127. (canceled)

128. The method of claim 103, wherein offering includes:
accessing a database of potential incremental passengers;
determining a match between the rights to be offered with transportation metadata associated with the potential incremental passengers; and
based on the match delivering the offerings to at least one potential incremental passenger.

129-153. (canceled)

154. A hierarchical web-based system for facilitating an offer of a portion of acquired air transportation rights, comprising:
a communication and notification facility for providing time-based offers of a portion of the acquired air transportation rights to incremental passengers using a hierarchical notification process;
a rights offer guideline facility for providing seat pricing and flight segment guidelines;
a reservation facility for accepting the time-based offers; and
a transaction facility to facilitate purchasing the offered rights.

155. The system of claim 154, wherein the time-based offers are provided by an electronic message.

156. The system of claim 155, wherein the electronic message includes a phone message.

157. The system of claim 154, wherein the portion of the acquired air transportation rights includes an empty leg.

158. The system of claim 154, wherein the acquired air transportation rights includes exclusive use of an aircraft.

159. The system of claim 154, wherein the portion of the acquired air transportation rights includes exclusive use of an aircraft.

160-173. (canceled)
